(19) United States
(12) Patent Application Publication
(10) Pub. No.: US 2010/0051553 A1
(43) Pub. Date: Mar. 4, 2010

(54) METHOD FOR REMOVING MERCURY FROM WASTEWATER AND OTHER LIQUID STREAMS

(75) Inventors: Gerald C. Walterick, JR., Levittown, PA (US); Stephen R. Vasconcellos, Doylestown, PA (US); Deborah Gereaghty, Delanco, NJ (US)

Correspondence Address: WEGMAN, HESSLER & VANDERBURG, 6055 ROCKSIDE WOODS BOULEVARD, SUITE 200, CLEVELAND, OH, 44131, US

(73) Assignee: GENERAL ELECTRIC COMPANY, Schenectady, NY (US)

(21) Appl. No.: 12/201,628

(22) Filed: Aug. 29, 2008

(51) Int. Cl. C02F 1/44; C02F 1/52; C02F 101/20

(52) U.S. Cl. 210/651; 210/719

(57) ABSTRACT

A method for reducing the amount of Mercury in a liquid stream, such as an aqueous wastewater or process water stream or a non-aqueous liquid hydrocarbonaceous stream is disclosed wherein the liquid stream is contacted with an effective amount of a Hg-complexing agent, the mercury contaminants in the liquid stream form insoluble complexes with the Hg-complexing agent, then the insoluble complexes are removed from the liquid stream via microfiltration or ultrafiltration techniques including the use of submerged hollow fiber ultrafilters or the like.

### FIELD OF INVENTION

The present invention relates to methods for reducing the Hg content of aqueous waste and process water streams and non-aqueous liquid hydrocarbonaceous streams.

### BACKGROUND OF THE INVENTION

Mercury, Hg, is an element found in a variety of everyday uses such as in fossil fuels, batteries, thermometers, fluorescent lights, dental fillings, and in weapons production. Quite obviously, when released to the environment, Hg can cause serious health problems. Growing concerns center around the amount of Hg that can accumulate in fish and animal tissue which in turn may be increased in humans after consumption of such contaminated species. In fact, with regard specifically to weapons production, the Department of Energy (DOE) has identified Hg separation and removal as a high priority concern in the cleanup of past weapons production activities. Mercury bearing DOE wastes are primarily aqueous and non-aqueous liquids, sludges, soils, adsorbed liquids, etc.

Wastewater treatment plants receive Hg containing wastewater from a variety of sources, such as residential, commercial and industrial sources, including dental clinics, medical facilities, power plants, mining operations, waste and sewage sludge incineration, and petrochemical refineries and processes. Increasing amounts of Hg have been noted lately in industrial wastewater from microelectronics manufacturing facilities, specifically LCD manufacturers, automotive wastewater, and others.

To protect the health of humans and the environment, stringent regulations have recently been implemented that restrict the allowable effluent discharge concentration of mercury to extremely low levels (≦10 parts per trillion in some instances). As a result of these new regulations, there is an urgent need for wastewater treatment methods that are capable of reducing mercury to concentrations that cannot be achieved using existing technologies.

### SUMMARY OF THE INVENTION

A method for reducing the amount of Mercury in an aqueous wastewater or process water stream or a non-aqueous liquid hydrocarbonaceous stream is disclosed wherein the liquid stream is contacted with an effective amount of a Hg-complexing agent, the liquid stream is mixed to facilitate the formation of insoluble Hg complexes between the Hg-complexing agent and the Hg contaminants in the liquid, and then the insoluble Hg complexes are removed from the liquid stream via a filtration process, such as microfiltration or ultrafiltration including the use of submerged ultrafiltration membranes or the like.

### DETAILED DESCRIPTION

The invention provides for methods of reducing Hg content in liquid media including aqueous wastewater and process water streams and non-aqueous streams such as are common in petroleum refining processes or petrochemical processes.

The petroleum refining process and petrochemical process streams that may benefit from the invention may, for example, include petroleum hydrocarbons such as petroleum hydrocarbon feedstocks including crude oils and fractions thereof such as naphtha, gasoline, kerosene, diesel, jet fuel, fuel oil, gas oil, vacuum residual, etc. Similarly, petrochemical process streams include olefinic or napthenic process streams, ethylene glycol, aromatic hydrocarbons, and their derivatives. These and others are referred to herein as liquid hydrocarbonaceous media.

Mercury contaminated aqueous based wastewater and process water streams may originate from a host of residential, commercial, industrial, and governmental sources such as those previously referred to and including petroleum refineries, coal fired power plants, mineral processing plants, mining operations, semiconductor manufacturing plants, metals operations, power operations, and automotive manufacturing plants.

In one exemplary embodiment of the invention, the aqueous or liquid hydrocarbonaceous stream containing Hg, (which may be present as elemental Hg, ionic Hg, inorganic mercury compounds, or organic mercury compounds), is contacted with a chemical additive comprising a polymeric dithiocarbamic acid salt (DTC). In one exemplary embodiment, the DTC is a water soluble branched polydithiocarbamic acid salt having the formula:

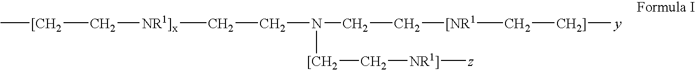

wherein R¹ independently is —H or —CS₂R², R² independently is H or a cation, and the sum of x, y, and z is an integer greater than 15 and wherein either the molecular weight of the polydithiocarbamic acid salt is less than 100,000 and more that 50 mole percent of R¹ are —CS₂R² or the molecular weight of the polydithiocarbamic acid salt is greater than 100,000.

These polymeric DTCs are well know and are reported in U.S. Pat. No. 5,523,002 incorporated by reference herein. The branched water soluble DTC of Formula I as stated in the '002 Patent is prepared by reacting poly[ethyleneimine] (PEI) with carbon disulfide in the presence of base to yield water soluble, branched, polymeric DTC represented by the formula:

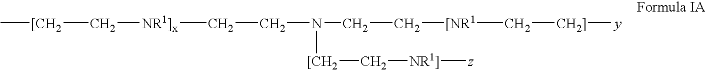

wherein R¹ independently represents —H or —CS₂R² which may be the same or different for each representation; R² each independently represents H or a cation; and the sum of x, y, and z is an integer greater than 15 and wherein either the molecular weight of the polydithiocarbamic acid salt is less than 100,000 and more than 50 mole percent of R¹ are —CS₂R², or the molecular weight of the polydithiocarbamic acid salt is greater than 100,000. At molecular weights greater than 100,000, the degree of functionalization of R¹ is not limited.

In one exemplary embodiment of the invention, >50 mole percent of R¹ are —CS₂R², R² is an alkali metal, and the sum of x, y, and z is an integer greater than 100.

In a particularly preferred embodiment of the invention, >80 mole percent of R¹ are —CS₂R², R² is an alkali metal, and the sum of x, y, and z is an integer greater than 500.

One particularly preferred DTC polymer is formed from PEI/CS₂ with 80% functionalization and a mw of about 170,000.

In another exemplary embodiment, the polymeric DTC is a branched water soluble polymer prepared by reaction of epichlorohydrin (EPI) with a mixture wherein the mixture includes, primarily, an amine compound consisting of at least two primary amine functionalities such as ethylenediamine (EDA) and an amine compound consisting of at least three primary amine functional groups, such as tris(2-aminoethyl)amine (TREN), then functionalized with CS₂. The general structure of the resulting polymeric DTC is represented by the following formula:

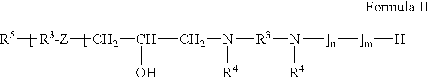

wherein R³ independently represents an organic radical which may be the same or different for each representation of R³ or:

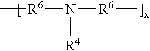

wherein R⁶ independently represents an organic radical which may be the same or different for each representation of R⁶ and x=1 to 5; R⁴ independently represents —H or —CS₂R⁷ which may be the same or different for each representation of R⁴, and R⁷ each independently represents H or a cation which may be the same or different for each representation of R⁷; R⁵ represents N or a substituted organic radical; Z represents N—R⁴, O, or S which may be the same or different for each representation of Z; the sum of n is an integer greater than 10; and m is an integer greater than 2.

In one exemplary embodiment of the invention, R³ is an ethylene radical, the sum of n is greater than 10, m=3, R⁵═N, >50% of R⁴ are —CS₂R⁷, R⁷ is an alkali metal and Z is N—R⁴.

In another embodiment of the invention, R³ is an ethylene radical, the sum of n is greater than 25, m=3, R⁵═N, >50 % of R⁴ are —CS₂R⁷, R⁷ is an alkali metal and Z is N—R⁴.

In another embodiment of the invention, R³ is an ethylene radical, the sum of n is greater than 25, m=3, R⁵═N, >79 % of R⁴ are —CS₂R⁷, R⁷ is an alkali metal and Z is N—R⁴.

The polymer DTCs shown and described above in Formula II are well known and are reported in U.S. Pat. No. 5,658,487, incorporated by reference herein.

As stated in the '487 patent, the polymeric DTCs of Formula II are prepared by reacting a polyamine, consisting of mainly secondary amine functionality, with carbon disulfide in an aqueous solution. The polyamines of one embodiment generally have a branched structure as a result of addition of crosslinking compounds during manufacture.

In one embodiment of the invention, aqueous solutions are prepared by first reacting a mixture of primarily an amine compound consisting of at least two primary amine functional groups, and an amine compound consisting of three primary amine functional groups, with an epihalohydrin to yield a branched water soluble polyamine consisting of mainly secondary amine functionality. The synthesis is conducted by methods known to those skilled in the art to prevent gelation of the polyamine compound. For a general review of methods to control the molecular weight and branching of the polymeric compounds, see Allcock et al., Contemporary Polymer Chemistry, Chapter 11, Prentice-Hall, Inc., N.H. 1981. Compounds suitable for preparing the polyamine compositions in this and other embodiments of the present invention are well known to those skilled in the art. Representative compounds consisting of at least two primary amine functional groups include, but are not limited to, ethylenediamine (EDA), propylenediamine, diethylenetriamine (DETA), tripropyl-enetetramine, 1,3-diamino-2-hydroxypropane, bis(hexamethylenetriamine) (BHMT), Jeffamine® polyoxyalkylenenamines commercially available from Texaco, triethylenetetramine (TETA), tetraethylenepentamine (TEPA), and polyethyleneimine. Representative crosslinking compounds consisting of at least three primary amine functional groups include, but are not limited to, melamine or tris(2-aminoethyl)amine (TREN). Non-amine compounds such as, but not limited to, glycerol, pyrogallol, and pentaerythritol can be utilized as the branching agent.

In the embodiment of the invention encompassed by Formula II, the polyamine synthesis is typically conducted under atmospheric conditions initially at about 30° C. to 70° C. utilizing a substoichiometric amount of epihalohydrin as determined by the method of Allcock et al. The mixture is then heated to 70° C. to 100° C. and additional epihalohydrin is charged until the desired molecular weight is achieved, typically determined by monitoring the viscosity of the system. The polyamine product is then reacted with carbon disulfide to produce dithiocarbamic acid salts.

Polymers preferred under Formula II are terpolymers from EDA/TREN/EPI that are functionalized with CS₂ resulting in greater than 50% CS₂ functionality. Exemplary EDA/TREN/EPI DTCs include CS₂ functionalities of about 50%-80% at 25% active levels and exhibit viscosities of from about 18 to about 120 centipoise measured at 25° C.

The aqueous or liquid hydrocarbonaceous stream having Hg therein is brought into contact with the polymeric DTC. The Hg may be present in elemental, or ionic form or it may be present as part of a compound such as HgCl₂, Hg(OH)₂, phenylmercury, alkoxyalkylmercury, methylmercury, etc. In one exemplary embodiment, from about 0.1 to about 10,000 mg/L of the DTC is added to the Hg containing liquid stream with a preferred addition rate being in the order of about 1 to about 100 mg/L.

The liquid stream is mixed for a sufficient time to allow the DTC precipitating agent to form insoluble complexes with the Hg. Then, in another exemplary embodiment, the insoluble Hg complexes may be removed from the liquid stream via microfiltration and/or ultrafiltration techniques. Exemplary separation processes include the use of microfilter (MF) and/or ultrafilter (UF) membrane separation techniques. Typical pore sizes of the microfilters are on the order of about 0.1 to about 10 μm with typical ultrafiltration membranes characterized by pore sizes of about 0.001 to about 0.1 μm. The UF or MF membranes may be made of a polymeric material, such as polyvinylidene fluoride (PVDF) or a ceramic material such as titanium oxide, zirconium oxide or aluminum oxide. The physical configuration of the UF or MF membranes may be hollow fiber, tubular, flat sheet or spiral wound. The direction of water flow through the hollow fiber UF or MF membranes may be outside-in or inside-out. Submersed UF and MF membranes can be employed advantageously due to their low flux operation rates.

Presently, preferred ultrafiltration membranes are part of the “Zeeweed™” membrane technology products sold by General Electric Co. These membranes are hollow fiber membranes that are completely immersed in the liquid stream containing Hg. Under a low pressure suction action, a pump draws the liquid stream through billions of microscopic pores in the membrane fibers. The Hg contaminants, after being complexed with the chemical additive, are larger than the pores, so they will not pass through the membrane with the liquid. This results in a filtrate that contains an extremely low concentration of Hg. The outside-in flow path means that the membranes do not require a pressure vessel; however, in some configurations, the MF or UF membranes may be enclosed in a pressure vessel to allow operation at higher pressures. These membranes are available in modules with each module containing thousands of hollow membrane fibers positioned therein. Suitable operating parameters for use of the Zeeweed membranes are transmembrane pressures of about 0 to 20 psig vacuum and flux of about 10 to 300 LMH (liters per square meter per hour).

After the separation process, the filtrate may be subjected to additional membrane or other purification systems, and the filter backwash water (reject containing Hg) may be sent for additional dewatering or disposal.

Preliminary data indicate that the method of the invention is capable of reducing Hg levels to=<10 ng/l.

The invention will now be further described in the following examples. These examples are offered to illustrate the invention and should in no way be viewed as limiting or restricting the invention.

### EXAMPLES

In order to demonstrate the efficacy of this invention, laboratory tests were conducted with samples of mercury-contaminated wastewater obtained from a refinery and a power plant.

In tests with the refinery wastewater, MetClear™ MR2405 was added at dosages of 0, 2, 5, 10, 20 and 50 mg/liter to samples of wastewater containing 24.9 ng/l (ng/l=nanograms/liter=parts per trillion) Hg. The treated samples were mixed identically using a Phipps and Bird Jar Tester, then each sample was filtered through a Zeeweed™ 500 hollow fiber ultrafilter. Filtrate samples representing each treatment were analyzed for low level mercury content by a certified independent lab using EPA Method 1631 “Mercury in Water by Oxidation, Purge and Trap, and Cold Vapor Atomic Fluorescence Spectrometry”. Results of the residual mercury analysis for each treatment are shown in Table 1, below:

TABLE 1

| | | Treatment | | |
|---|---|---|---|---|
| Sample | Treatment | Dosage | Filter | Hg |
| Designation | Added | (mg/l) | Used | (ng/l) |
| Refinery | None | 0 | Unfiltered | 24.9 |
| Wastewater A | | | | |
| Test 1 | None | 0 | Zeeweed ™ 500 | 6.5 |
| | | | Ultrafilter | |
| Test 2 | MetClear ™ | 2 | Zeeweed ™ 500 | 1.9 |
| | MR2405 | | Ultrafilter | |
| Test 3 | MetClear ™ | 5 | Zeeweed ™ 500 | 1.1 |
| | MR2405 | | Ultrafilter | |
| Test 4 | MetClear ™ | 10 | Zeeweed ™ 500 | 0.9 |
| | MR2405 | | Ultrafilter | |
| Test 5 | MetClear ™ | 20 | Zeeweed ™ 500 | 0.6 |
| | MR2405 | | Ultrafilter | |
| Test 6 | MetClear ™ | 50 | Zeeweed ™ 500 | 0.7 |
| | MR2405 | | Ultrafilter | |

MetClear ™ MR2405 = DTC polymer formed from PEI/CS₂ as shown in Formula I above with 80% CS₂ functionalization mw ≈ 170,000.

A second series of tests were conducted with another sample of refinery wastewater containing 31.0 ng/l mercury. Using the same procedure described above, MetClear™ MR2405 was added at 0, 2, 5 and 10 mg/l. Results of this series of tests are shown in Table 2, below:

TABLE 2

| | | Treatment | | |
|---|---|---|---|---|
| Sample | Treatment | Dosage | Filter | Hg |
| Designation | Added | (mg/l) | Used | (ng/l) |
| Refinery | None | 0 | Unfiltered | 31.0 |
| Wastewater B | | | | |
| Test 7 | None | 0 | Zeeweed ™ 500 | 7.0 |
| | | | Ultrafilter | |
| Test 8 | MetClear ™ | 2 | Zeeweed ™ 500 | 1.8 |
| | MR2405 | | Ultrafilter | |
| Test 9 | MetClear ™ | 5 | Zeeweed ™ 500 | 1.5 |
| | MR2405 | | Ultrafilter | |
| Test 10 | MetClear ™ | 10 | Zeeweed ™ 500 | 1.3 |
| | MR2405 | | Ultrafilter | |

Results shown in Tables 1 and 2 demonstrate that the combined treatment, MetClear™ MR2405+ultrafiltration, is capable of achieving extremely low residual concentrations of mercury. This data also demonstrates that the addition of MetClear™ MR2405 significantly improves the removal of mercury by ultrafiltration.

In tests with the power plant wastewater, the same procedure described above was used to treat a sample of wastewater containing 871 ng/l mercury. In these tests, MetClear™ MR2405 was added to the wastewater at dosages of 0, 2, 5, 10, 20 and 50 mg/l. As above, the treated wastewater samples were mixed, then filtered through a Zeeweed™ 500 ultrafilter and then the filtrates were analyzed for residual mercury. Test results are shown in Table 3, below:

TABLE 3

| | | Treatment | | |
|---|---|---|---|---|
| Sample | Treatment | Dosage | Filter | Hg |
| Designation | Added | (mg/l) | Used | (ng/l) |
| Power Plant | None | 0 | Unfiltered | 871 |
| Wastewater | | | | |
| Test 11 | None | 0 | Zeeweed ™ 500 | 199 |
| | | | Ultrafilter | |
| Test 12 | MetClear ™ | 2 | Zeeweed ™ 500 | 29 |
| | MR2405 | | Ultrafilter | |
| Test 13 | MetClear ™ | 5 | Zeeweed ™ 500 | 17 |
| | MR2405 | | Ultrafilter | |
| Test 14 | MetClear ™ | 10 | Zeeweed ™ 500 | 13 |
| | MR2405 | | Ultrafilter | |
| Test 15 | MetClear ™ | 20 | Zeeweed ™ 500 | 11 |
| | MR2405 | | Ultrafilter | |
| Test 16 | MetClear ™ | 50 | Zeeweed ™ 500 | 10 |
| | MR2405 | | Ultrafilter | |

Results shown in Table 3 again demonstrate the ability of the combined treatment, MetClear™ MR2405+ultrafiltration, to achieve extremely low (≦10 ng/l) residual mercury concentrations. This data also demonstrates that the addition of MetClear™ MR2405 significantly improves the removal of mercury by ultrafiltration.

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the invention.

What is claimed is:

1. A method for reducing the amount of Hg in a liquid stream comprising:
a) adding to said liquid stream an effective amount for the purpose of a Hg-complexing agent;
b) mixing said liquid stream for a sufficient time to allow the Hg-complexing agent to form insoluble complexes with the elemental Hg and Hg compounds in the liquid;
c) removing the complexed Hg and complexed Hg compounds from the liquid by a filtration process.

2. A method as recited in claim 1 wherein said liquid stream is chosen from an aqueous waste stream or a liquid hydrocarbonaceous medium.

3. A method as recited in claim 2 wherein said Hg-complexing agent is a water soluble polymer containing sulfide functional groups.

4. A method as recited in claim 2 wherein the Hg-complexing agent is a polymeric dithiocarbamic acid salt.

5. A method as recited in claim 2 wherein said Hg-complexing agent comprises a member of the group consisting of polymeric dithiocarbamic acid salt (DTC) (I) and (II), wherein said polymeric DTC(I) is 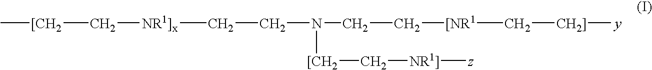
wherein R¹ independently is —H or —CS₂R², R² independently is H or a cation, and the sum of x, y, and z is an integer greater than 15 and wherein either the molecular weight of the polydithiocarbamic acid salt is less than 100,000 and more that 50 mole percent of R¹ are —CS₂R² or the molecular weight of the polydithiocarbamic acid salt is greater than 100,000;
and wherein said polymeric DTC(II) is 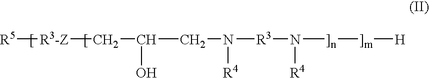
wherein R³ independently represents an organic radical which may be the same or different for each representation of R³ or 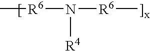
wherein R⁶ independently represents an organic radical which may be the same or different for each representation of R⁶ and x=1 to 5; R⁴ independently represents —H or —CS₂R⁷ which may be the same or different for each representation of R⁴, and R⁷ each independently represents H or a cation which may be the same or different for each representation of R⁷; R⁵ represents N or a substituted organic radical; Z represents N—R⁴, O, or S which may be the same or different for each representation of Z; the sum of n is an integer greater than 10; and m is an integer greater than 2.

6. A method as recited in claim 1 wherein said filtration process comprises passing said liquid stream through a microfilter or an ultrafilter.

7. A method as recited in claim 5 wherein step of adding a Hg-complexing agent to said liquid stream comprises adding from about 0.1 to about 10,000 mg of said polymeric DTC based upon 1 L of said liquid stream.

8. A method as recited in claim 7 wherein said step of adding a Hg-complexing agent to said liquid stream comprises adding from about 1 to about 100 mg of said polymeric DTC based upon 1 L of said liquid stream.

9. A method as recited in claim 6 wherein said filtration process occurs in either a submersed hollow fiber ultrafiltration membrane or a submersed hollow fiber microfiltration membrane.

10. A method as recited in claim 5 wherein said polymeric DTC(I) is present and wherein in said Formula I greater than 50 mole percent of R¹ is CS₂R², R² is an alkali metal and the sum of x, y, and z is an integer greater than 100.

11. A method as recited in claim 5 wherein said polymeric DTC(I) is present and wherein greater than 80 mole percent of R¹ are —CS₂R², R² is an alkali metal and the sum of x, y, and z is an integer greater than 500.

12. A method as recited in claim 5 wherein after said removal, said liquid stream comprises Hg in an amount equal to or less than 10 ng/L.

13. A method as recited in claim 5 wherein said polymeric DTC(II) is present and wherein in said Formula II R³ is an ethylene radical, the sum of n is greater than 10, m is 3, R⁵ is N, more than 50% of R⁴ are —CS₂R⁷, R⁷ is an alkali metal and Z is N—R⁴.

14. A method as recited in claim 5 wherein said polymeric DTC(II) is present and wherein in said Formula II, R³ is an ethylene radical, the sum of n is greater than 25, m is 3, R⁵ is N, more than 50% of R⁴ are —CS₂R⁷, R⁷ is an alkali metal and Z is N—R⁴.

15. A method as recited in claim 5 wherein R³ is an ethylene radical, the sum of n is greater than 25, m is 3, R⁵ is N, more than 79% of R⁴ are —CS₂R⁷, R⁷ is an alkali metal and Z is N—R⁴.
